(19) United States
(12) Patent Application Publication
(10) Pub. No.: US 2008/0286740 A1
(43) Pub. Date: Nov. 20, 2008

(54) CONSTRUCTIONISM LEARNING SUPPORT SYSTEM UTILIZING ONLINE GAME AND METHOD FOR THE SAME

(75) Inventors: Jong Hyun WI, Seoul (KR); Eun Sok WON, Seoul (KR)

Correspondence Address: GREENBLUM & BERNSTEIN, P.L.C., 1950 ROLAND CLARKE PLACE, RESTON, VA, 20191, US

(73) Assignee: Jong Hyun WI, Daejeon (KR)

(21) Appl. No.: 11/966,015

(22) Filed: Dec. 28, 2007

(30) Foreign Application Priority Data
May 14, 2007 (KR) 10-2007-0046594

(51) Int. Cl. G09B 5/00

(52) U.S. Cl. 434/350; 463/42; 434/356

(57) ABSTRACT

Disclosed is a constructionism learning support system based on an online game and a method for the same, and more particularly to a constructionism learning support system utilizing an online game and a method for the same, which can support collaborative learning, task-based learning, and problem-based learning based on a constructionism learning theory. The system for supporting constructionism learning utilizing an online game, including: a learning support server including a quest management unit for receiving and managing a quest input by a learning manager on online prior to learning and a constructionism learning support unit for supporting collaborative learning based on the input quest through construction of a learning community, task-based learning of performing the quest, and problem-based learning of performing the task given from the quest; an online learning game server including a game-learning interlock unit interlocking with the learning support server so as to progress a role-playing game in real time, and a lesson management server interlock unit interlocking with a lesson management server so as to collect and transfer log information of a learner, such as information on a participant, lesson contents, results, or the like; the lesson management server including a lesson participant management unit for authorizing the learner, a lesson statistics management unit for managing lesson-related statistics, such as lesson progresses, evaluation, and academic achievement, and an interlock control unit for controlling the interlock of the learning support server with the online learning game server, and the interlock of the lesson participant management unit and the lesson statistics management unit; and multiple learner terminals connecting to the learning game server so as to simultaneously enjoy a game and learn in real time. The disclosed supports collaborative learning, task-based learning, and problem-based learning utilizing the online game based on the constructionism learning theory, so as to improve efficacy and interest of the learner and improve the learning effect. Further, the learning manager (teacher) can provide various learning tasks through the learning support system, and efficiently manage the learning-related matter, such as the lesson progress and evaluation, or the like.

### BACKGROUND OF THE INVENTION

1. Field of the Invention

The present invention relates to a constructionism learning support system based on an online game and a method for the same, and more particularly to a constructionism learning support system utilizing an online game and a method for the same, which can support collaborative learning, task-based learning, and problem-based learning based on a constructionism learning theory.

2. Description of the Prior Art

Computer games do not only cultivate a user's logic and creative thinking and be of help to a learner's achievement, challenge, and imagination, but also improve interaction and a problem solving ability through play of a computer game, so research and development into an education utilizing the games have been actively progressed.

For one of the research for a teaching utilizing the game, Squire utilized “Civilian III” with western history for history lessons, and a learner utilized experiences obtained from the free play of “Civilian III” and social life together so as to solve problems, and thus came to acquire the knowledge of geography and history of western civilization.

Further, Shaffer and Gee developed “Madison” with developing a city, so that learners could understand every complex problem necessary for developing the city. Further, they utilized the game of “Digital Zoo”, in which the learner takes on a role of a manager of a zoo for the lesson, so that the learner could acquire scientific and biological knowledge through the lesson.

A learning procedure based on a constructionism theory defines a procedure in which the learner actively acquires the knowledge in an environment to which the learner belongs. The learning in the constructionism is constructed in a procedure of recognizing a real life, and when the learner is in contact with a new concept, the learner interprets and reconstructs the concepts through interaction of the already-constructed experience of the learner with the society to which the learner belongs.

As shown in FIG. 1, in constructionism learning, the learning methods of collaborative learning, problem-based learning, and task-based learning are used, and the learners constitute a small group so as to participate a whole learning activity.

As described above, online learning games for education and learning has been developed and utilized. However, the system in which the game, such as an adventure, a role-playing game, or the like, is organically interlocked with learning contents, such as a quest enabling the learner to learn while simultaneously performing a predetermined mission so as to support the learning, in order to effectively go side by side with the learning and the game online based on the constructionism learning theory, has not been developed.

Further, multiple players constitute a community through a network and interact within the community in the above online and PC game, so that a system for providing a lesson manager's convenience in the management including an effective learning evaluation and the management of multiple learners has been required.

### SUMMARY OF THE INVENTION

Accordingly, the present invention has been made to solve the above-mentioned problems occurring in the prior art, and the present invention provides a constructionism learning support system utilizing an online game in order to effectively implement a learning procedure employing a constructionism learning theory utilizing an online game.

It is another object of the present invention to provide a constructionism learning support system utilizing an online game in which a learning manager can write and manage an appropriate quest based on the progress of a lesson in order to utilize an online game for a teaching activity.

It is another object of the present invention to provide a constructionism learning support system utilizing an online game in which a performance result of constructionism learning and a quest through a game is collected and analyzed, and a lesson progress, a result evaluation, or the like, are conveniently implemented through an automatic system.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating three kinds of learning procedures based on a constructionism theory;

FIG. 2 is a view illustrating a lesson progress based on a constructionism theory;

FIG. 3 is a diagram illustrating a constructionism learning support system utilizing an online game according to the present invention;

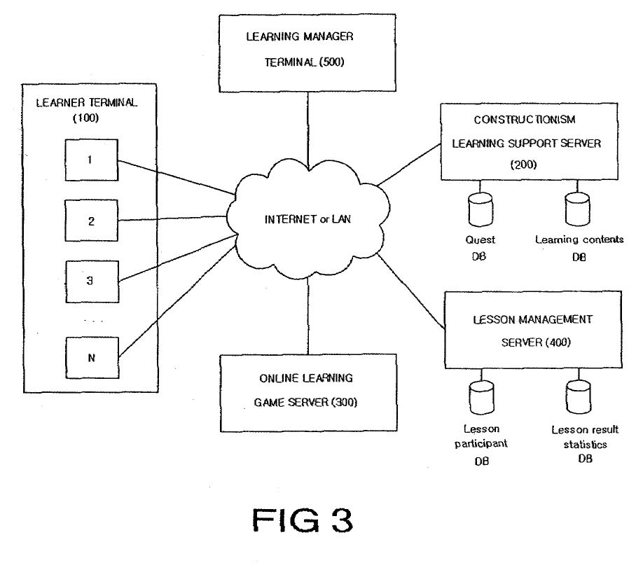

FIG. 4 is a diagram illustrating a constructionism learning support server in a constructionism learning support system utilizing an online game according to an exemplary embodiment of the present invention;

FIG. 5 is a diagram illustrating an online learning game server in a constructionism learning support system utilizing an online game according to the present invention; and

FIG. 6 is a diagram illustrating a lesson management server in a constructionism learning support system utilizing an online game according to the present invention;

### DETAILED DESCRIPTION OF THE EXEMPLARY EMBODIMENTS

Hereinafter, a exemplary embodiment of the present invention will be described with reference to the accompanying drawings. In the following description and drawings, the same reference numerals are used to designate the same or similar components, and so repetition of the description on the same or similar components will be omitted.

The present invention relates to a constructionism learning support system based on an online game and a method for the same, and more particularly to a constructionism learning support system utilizing an online game and a method for the same, which can support collaborative learning, task-based learning, and problem-based learning based on a constructionism theory.

The present invention relates to a constructionism learning support system utilizing an online game which includes: a learning support server 200 including a quest management unit 210 for receiving and managing a quest input by a learning manager on online prior to learning and a constructionism learning support unit 220 for supporting collaborative learning based on the input quest through a learning community, task-based learning of performing the quest, and problem-based learning of performing the task given from the quest; an online learning game server 300 including a game-learning interlock unit 310 for interlocking with the learning support server 200 so as to progress a role-playing game in real time, and a lesson management server interlock unit 320 interlocking with a lesson management server 400 so as to collect and transfer log information of a learner, such as information on a participant, lesson contents, results, or the like; the lesson management server 400 including a lesson participant management unit 410 for authorizing the learner, a lesson statistics management unit 420 for managing particular lesson-related statistics, such as a lesson progress, evaluation, and academic achievement, or the like, and an interlock control unit for controlling the interlock of the learning support server 200 with the online learning game server 300, and the interlock of the lesson participant management unit 410 and the lesson statistics management unit 420; and multiple learner terminals 100 connecting to the learning game server so as to simultaneously enjoy a game and learn in real time.

Further, the learning support server of the present invention includes a quest database for storing and managing the quest serving as a learning task designed based on subjects and a constructionism learning contents database for storing and managing a learning scenario and contents for collaborative learning, task-based learning, and problem-based learning.

Further, the lesson management server 400 of the present invention includes a lesson participant database 430 for managing personal information, authorization information, or the like, of the learner, and a lesson result/statistics database for storing and managing lesson contents, evaluation results, or the like, of the learner.

First, in the constructionism learning theory serving as the base of the present invention, the learning is constructed through a process of recognizing the real world, and if the learner meets a new concept, the learner interprets and reconstructs the concepts through an interaction of already-constructed experience of the learner with the society to which the learner belongs. Further, the learner in the constructionism learning comes to construct and interpret the real world based on his/her experience, in such that knowledge of the learner is based on physical and social experiences understood by the learner oneself.

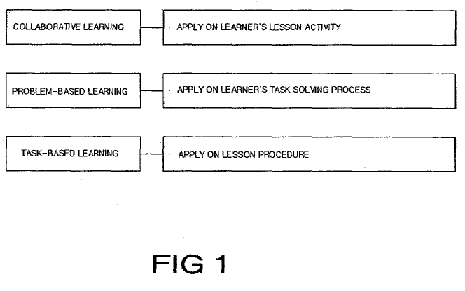

To date, various teaching methods based on the constructionism theory have been proposed. Among them, as shown in FIG. 1, the present invention employs the teaching method based on collaborative learning, task-based learning, and problem-based learning.

First, collaborative learning refers to a learning strategy in which the learners are divided into small groups and engage in a common learning task through the interaction of the learner so as to achieve common education goal.

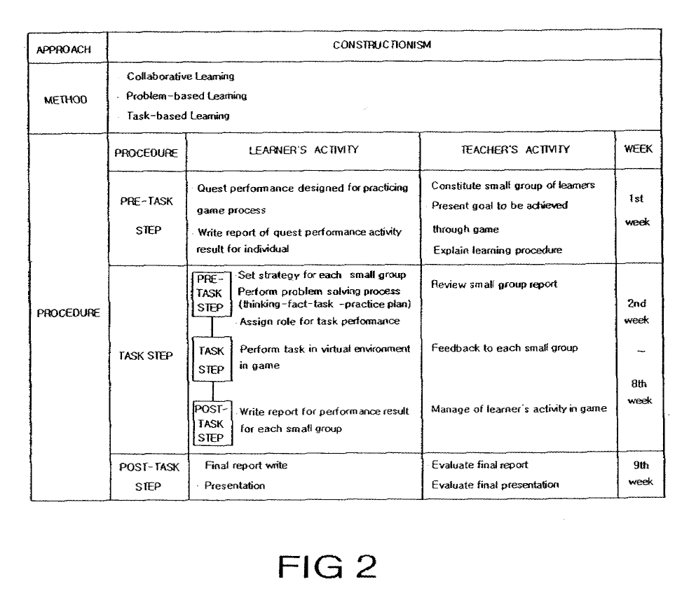

Task-based learning refers to a learning strategy in which a teacher provides a task appropriate for a learning goal with the learners and procedures a learning activity for the learning to solve the task. As shown in FIG. 2, the task-based learning is divided into three steps: a pre-task step, a task step, and a post-task step.

In the pre-task step, the teacher presents an object for the task performance and a goal to be achieved to the learner and informs the learner of directions necessary for performing the task. In the task step, the learner directly performs the task for achieving the presented goal and participates a lesson activity so as to perform the task so that the learner-oriented learning activity is performed.

Finally, in the post-task step, the learner organizes and presents the results acquired through the task performance. In this step, the learner comes to be in contact with the performance results of other learners so as to occur the interaction between learners or between the teacher and the learner.

The problem-based learning is a teaching method and a learning environment as well, in which thought, knowledge, technology and processes acquired by an experience and intuition are organized in a general and systematic manner to be presented.

The constructionism learning support system utilizing the online game based on the above constructionism learning theories and the method for the same will be specifically described with reference to the accompanying drawings.

The present invention includes the quest management unit 210 for receiving and managing the learning quest, the learning support server 200 including the constructionism learning support unit 220 for supporting collaborative learning through the community, the task-based learning of performing the quest, and the problem-based learning of performing the task given from the quest; the online learning game server 300 including the game-learning interlock unit 310 for interlocking with the learning support server 200 so as to progress the role-playing game in real time and the lesson management server interlock unit 320 interlocking with the lesson management server 400 so as to collect and deliver log information of the learner, such as information on the participant, lesson contents, results, or the like, the lesson management server 400 for managing the lesson participant and lesson-related statistics, and the multiple learner terminals 100 connecting to the learning game server so as to allow the learner to simultaneously enjoy the game and learn in real time.

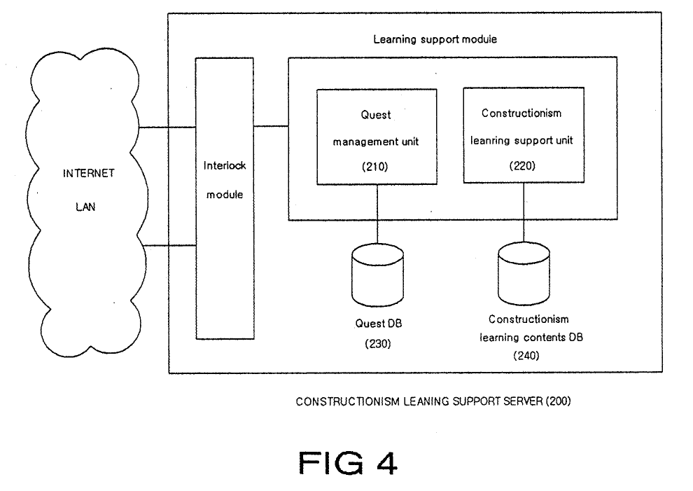

FIG. 4 illustrates the constructionism learning support server 200 according to an exemplary embodiment of the present invention. The constructionism learning support server 200 includes the quest management unit 210 for receiving and managing the quest input by the learning manager (teacher) online prior to learning, and the constructionism learning support unit 220 for supporting collaborative learning based on the input quest through the learning community, the task-based learning of performing the quest, and the problem-based learning of performing the task given from the quest.

Further, the learning support server 200 further includes a quest database 230 for storing and managing the quest designed for each subject and lesson date and the constructionism learning contents database 240 for storing and managing the learning scenario and contents for collaborative learning, task-based learning, and problem-based learning.

The quest is a series of predetermined missions used in the online game. The learning manager provides the quest, such as objectives, missions, and necessary sources, or the like, for each preset lesson date relating to the learning contents, and the lesson participant progresses in the online game through the learner terminal 100 and reads the quest from the quest management unit 210 of the learning support server 200 so as to perform the quest.

The learning manager can access the constructionism learning support server 200 through a learning manager terminal 500, and then request writing of the quest for each subject and lesson date through the quest management unit 210. Then, when the written quest is received, the received quest is stored and managed in the quest database 230, so that the quest stored in the quest database 230 can be amended and added in the learning manager terminal 500 when necessary.

Further, the learning manager terminal 500 receives the learning knowledge and the scenario to be acquired for each subject together with the game through the constructionism learning support unit 220 of the learning support server 200 for each subject and lesson date so as store the learning knowledge and the scenario depending on collaborative learning, task-based learning, and problem-based learning.

Further, in order to employ the online game to the education through the present invention, the learning manager (teacher, professor, or the like) selects the subject and the lesson objectives, and then selects the online game appropriate for the selected subject and lesson objectives. In the present invention, an administration strategy subject for university students, and a politics subject for elementary school students are selected so as to be applied to the actual lesson. Among the online games, an online transaction system appropriate for the subjects is implemented, and ‘Goonzu Online’ of ‘nDOORS company’ which is less violent and is capable of constructing the political system, is selected and applied to the present invention.

The learner receives the quest for each subject and lesson date from the learning support server 200 through the learner terminal 100, and accesses the online learning game server 300 so as to perform the online game.

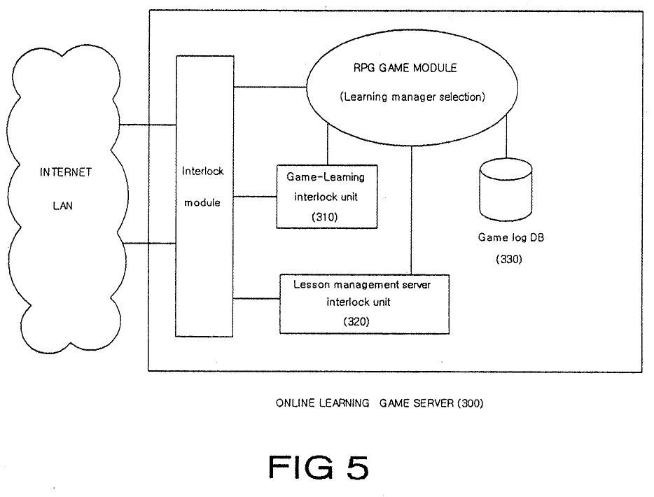

As shown in FIG. 5, the learning knowledge and the learning scenario information based on the constructionism stored in the learning support server 200 are supplied to the multiple learner terminals 100 through the game-learning interlock unit 310 of the online game server 300 while the online game is performed. Herein, the learning knowledge and the learning scenario are previously written through combining characterized elements of the online game selected by the learning manager.

The learner performs the constructionism learning procedure interlocked with the learning support server 200 according to the learning scenario while performing the online game provided from the online learning game server 300 through the learner terminal 100. Further, the learner can perform the mission according to the quest provided from the learning support server 200 and transfer and store the result of the mission to the lesson management server 400 in a form of a report.

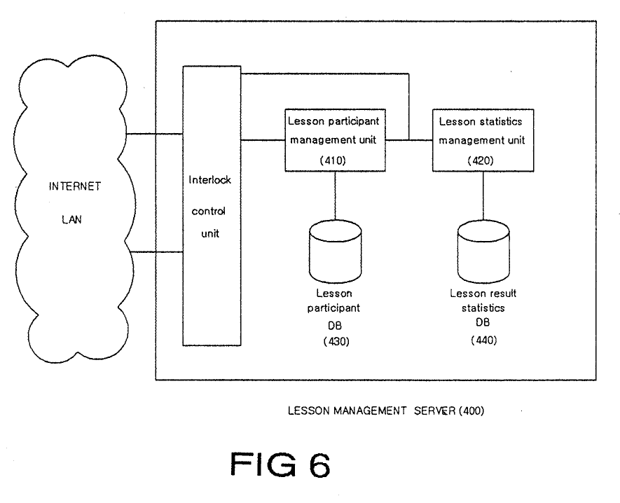

As shown in FIG. 6, the lesson management server 400 collects the performance results of the quest transferred for each individual and group through the lesson statistics management unit 420 so as to store the collected result in a lesson result statistics database 440. Further, log data performing the online game through the lesson management server interlock unit 320 of the learning game server 300 is transferred through an interlock control unit of the lesson management server 400 so as to store the log data in the lesson result statistics database 440 for each individual and group.

The information stored in the lesson result statistics database 440 is analyzed and processed through the lesson statistics management unit 420 so as to generate a result report of the lesson evaluation, and the generated result report can be fed back to multiple learners under the authorization of the learning manager.

The lesson management server 400 includes a lesson participant management unit 410 for registering and authorizing the lesson participant, and the lesson participant database 430 for storing information on the participant registered through the lesson participant management unit.

The learning support server 200 and the lesson management server 400 can be unified to one server according to a number of users, performance of the server, and the size of the database.

The present invention provides a method for supporting constructionism learning using an online game in a constructionism learning support system utilizing an online game including an online learning game server 300, a lesson management server 400, a learner terminal 100, and a learning manager terminal 500, which includes the steps of: (a) receiving quest information, including a lesson goal, a mission, a necessary resource, and an evaluation list for each lesson date and subject, input through a learning manager terminal 500 from a learning manager by a quest management unit 210 of a learning support server 200 so as to store the received quest information in a quest database 230; (b) receiving an input of learning knowledge and a learning scenario to be acquired by a learner for each subject and date, and storing the input learning knowledge and the learning scenario in a constructionism learning contents database 240 by a constructionism learning support unit 220 of the learning support server 200; (c) receiving a learning quest and the learning knowledge stored in the quest database 230 and the constructionism learning contents database 240 of the learning support server 200 by an online learning game server 300 so as to constitute a learning community, and to prepare an online game for the learner to perform task-based learning of performing the quest and problem-based learning of performing a task given from the quest; (d) authorizing a user according to lesson participation of the learner in the learner terminal 100, and transferring a particular learning quest and learning knowledge stored in the quest database 230 and the constructionism learning contents database 240 of the learning support server 200 according to a request of the learner by a lesson management server 400; (e) receiving input information according to a game progress from the learner terminal 100 and supporting learning performance by the online learning game server 300; and (f) receiving an activity and a task performed based on the learning quest of the learner from the online game server 300 by a lesson management server 400 so as to store them.

The method for supporting constructionism learning using an online game further includes the steps of: (g) receiving a lesson result and lesson statistics, including a state of lesson progress of the learner, a result of lesson evaluation and achievement, from the learning support server 200 and the online game server 300 so as to calculate and store them by the lesson management server 400; (h) feeding back and transmitting the lesson result and statistics to the learning manager terminal 500 and the learner terminal 100 according to a reading request of the learning manager and the learner; and (i) automatically writing and printing a status of the community, a written task, and a learning evaluation result for each individual and community in a form of a report.

Further, in step (d), a user can be classified into a learning participant pre-designated by the learning manager and other participants to be authorized, and in step (c), the task performed based on the learning quest by the learner is classified by each learner, lesson date, and community, and the result of the task performance.

As described above, the present invention can support collaborative learning, task-based learning, and problem-based learning utilizing the online game based on the constructionism learning theory through input and application of various quests.

Further, the present invention simultaneously and effectively provides online game and the learning so as to improve efficacy and interest of the learner and improve the learning effect through promoting the interaction. Further, the learning manager (teacher) can provide various learning tasks through the learning support system, easily manage the learning contents and learning antecedents, manage the lesson progress and evaluation, or the like, and take statistics on lesson-related matters through the system, thereby improving the convenience of the lesson management based on the online game.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A system for supporting constructionism learning utilizing an online game, comprising:
a learning support server including a quest management unit for receiving and managing a quest input by a learning manager on online prior to learning and a constructionism learning support unit for supporting collaborative learning based on the input quest through construction of a learning community, task-based learning of performing the quest, and problem-based learning of performing the task given from the quest;
an online learning game server including a game-learning interlock unit interlocking with the learning support server so as to progress a role-playing game in real time, and a lesson management server interlock unit interlocking with a lesson management server so as to collect and transfer log information of a learner, such as information on a participant, lesson contents, results, or the like;
the lesson management server including a lesson participant management unit for authorizing the learner, a lesson statistics management unit for managing lesson-related statistics, such as lesson progresses, evaluation, and academic achievement, and an interlock control unit for controlling the interlock of the learning support server with the online learning game server, and the interlock of the lesson participant management unit and the lesson statistics management unit; and
multiple learner terminals connecting to the learning game server so as to simultaneously enjoy a game and learn in real time.

2. The system as claimed in claim 1, wherein the learning support server comprises a quest database for storing and managing the quest designed and input for each subject and lesson date and a constructionism learning contents database for storing and managing a learning scenario and contents for collaborative learning, task-based learning, and problem-based learning.

3. The system as claimed in claim 1, further comprising a learning manager terminal interlocked with the learning support server and the lesson management server through an information communication network of internet or LAN so as to input and correct the quest, manage the learning scenario and contents, and manage and control the servers.

4. The system as claimed in claim 1, wherein the lesson management server comprises a lesson participant database for managing personal information, and authorization information of the learner, and a lesson result/statistics database in which log data performing the online game through the lesson management server interlock unit is transferred to the lesson management server so as to manage information on the lesson statistics for each individual and group.

5. The system as claimed in claim 1, wherein the quest management unit receives a lesson goal, a mission, necessary resources, and an evaluation list for each lesson date and subject previously input through a learning manager terminal from a learning manager so as to store and manage corresponding information in a quest database.

6. The system as claimed in claim 1, wherein the constructionism learning support provides a user interface through which a learning manager can input learning contents, a learning scenario, and an evaluation standard for each lesson step that is composed of a pre-task step, a task step, and a post-task step classified depending on a lesson procedure, receives an input of learning knowledge and the learning scenario to be acquired for each subject and lesson date, and stores the input learning knowledge and scenario in the constructionism learning contents database.

7. A method for supporting constructionism learning utilizing an online game in a constructionism learning support system using an online game comprising a constructionism learning support server, an online learning game server, a lesson management server, a learner terminal, and a learning manager terminal, the method comprising the steps of:
(a) receiving quest information including a lesson goal, a mission, necessary resources, and an evaluation list for each lesson date and subject input through a learning manager terminal from a learning manager by a quest management unit of a learning support server, so as to store the received quest information in a quest database;
(b) receiving an input of learning knowledge and a learning scenario to be acquired by a learner for each subject and date, and storing the input learning knowledge and the learning scenario in a constructionism learning contents database by a constructionism learning support unit;
(c) receiving a learning quest and the learning knowledge stored in the quest database and the constructionism learning contents database of the learning support server by an online learning game server, so as to constitute a learning community, and to prepare an online game for the learner to perform task-based learning of performing the quest and problem-based learning of performing a task given from the quest;
(d) authorizing a user depending on lesson participation of the learner in the learner terminal and transferring the particular learning quest and learning knowledge stored in the quest database and the constructionism learning contents database of the learning support server according to a request of the learner by a lesson management server;
(e) receiving input information according to a game progress from the learner terminal and supporting learning performance by the online learning game server; and
(f) receiving an activity and a task performed based on the learning quest of the learner from the online game server by a lesson management server, so as to store them.

8. The method as claimed in claim 7, further comprising:
(g) receiving a lesson result and lesson statistics, including a state of lesson progress of the learner, a result of lesson evaluation, and achievement, from the learning support server and the online game server so as to calculate and store them by the lesson management server;
(h) feeding back and transmitting the lesson result and statistics to the learning manager terminal and the learner terminal according to a reading request of the learning manager and the learner; and
(i) automatically writing and printing a status of the community, a written task, and a learning evaluation result for each individual and community in a form of a report.

9. The system as claimed in claim 7, wherein, in step (d), a user can be classified into a learning participant pre-designated by the learning manager and other participant to be authorized.

10. The method as claimed in claim 7, wherein, in step (c), the task performed based on the learning quest by the learner is classified by each learner, lesson date, and community, and the result of the task performance can be received and stored.

11. A computer-readable recording medium in which a program for executing each step of claim 7 by a computer is recorded.

12. The system as claimed in claim 2, wherein the lesson management server comprises a lesson participant database for managing personal information, and authorization information of the learner, and a lesson result/statistics database in which log data performing the online game through the lesson management server interlock unit is transferred to the lesson management server so as to manage information on the lesson statistics for each individual and group.

13. The system as claimed in claim 8, wherein, in step (d), a user can be classified into a learning participant pre-designated by the learning manager and other participant to be authorized.

14. The method as claimed in claim 8, wherein, in step (c), the task performed based on the learning quest by the learner is classified by each learner, lesson date, and community, and the result of the task performance can be received and stored.

15. A computer-readable recording medium in which a program for executing each step of claim 8 by a computer is recorded.
